(19) United States
(12) Patent Application Publication
(10) Pub. No.: US 2005/0240680 A1
(43) Pub. Date: Oct. 27, 2005

(54) Method and apparatus for a life management server

(76) Inventors: Jose Costa-Requena, Helsinki (FI); Inmaculada Espigares, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/832,818

(22) Filed: Apr. 27, 2004

(51) Int. Cl. G06F 15/173; G06F 15/16

(52) U.S. Cl. 709/250

(57) ABSTRACT

A method and apparatus allows proximity connections to be established within a home network between a home platform and home devices. Each home device contains information that is automatically detected by the home platform. Once the home platform has determined that a difference exists between the information contained within each home device and the corresponding image on the home platform, the home platform initiates a synchronization of the information. The home platform disseminates information received from one home device to the other home devices within the home network if the information is to be shared. The home platform may also provide Internet Gateway Device (IGD) functionality in conformance with Universal Plug and Play (UPNP) specifications.

### FIELD OF THE INVENTION

This invention relates in general to proximity networks, and more particularly, to automatically synchronizing proximity networks.

### BACKGROUND OF THE INVENTION

Consumers are acquiring, viewing, and managing an increasing amount of digital media in the Computer Electronics (CE), mobile, and Personal Computer (PC) domains. Enjoyment of this digital media, regardless of the source, is becoming increasingly important in the home. To this end, the Digital Home Working Group (DHWG) is working to provide interoperable, home networked devices that provide new value propositions and opportunities for consumers and product vendors.

Today, there generally exists three categories of technology that serve the consumer in his or her home. First, there is the PC category that allows each consumer to interact with each other and other peripherals via the Internet. Second, there is the broadcast category that serves set-top boxes and other traditional consumer electronics, such as satellite television (TV) receivers, broadcast tuners, video and imaging capture devices, etc. Third, there is the mobile category, consisting of for example, multimedia mobile phones, Personal Digital Assistants (PDAs), laptop computers and similar devices that provide connectivity and freedom of movement into and out of the home environment, while operating within their own mobile network. The mobile networks may represent, for example, legacy networks operating under analog standards, or conversely they may represent the newer 3rd Generation (3G) Radio Access Networks (RANs), such as the Global System for Mobile Communications (GSM)/Enhanced Data Rates for Global Evolution (EDGE) and Wideband Code Division Multiple Access (WCDMA). Generally speaking, interoperability and ease of use of these technological categories will drive the success of the DHWG in its efforts to develop the home domain architecture.

As the home domain architecture continues to develop, interoperability not only requires a synchronization of data contained within the devices of each of the three technological categories, but interoperability also requires the ability to detect when a data synchronization may be required. Still further, once data synchronization occurs, applications that utilize the synchronized data should be automatically updated such that uniform results may be maintained across all devices within each category of the home domain.

Accordingly, there is a need in the home domain architecture that facilitates data management across all technology categories of a life management network. Additionally, focused attention should be applied to life management functionalities associated with the home domain to aid the consumer in his or her leisure and time management functions in a distributed manner across each device in the home domain.

### SUMMARY OF THE INVENTION

To overcome limitations in the prior art, and to overcome other limitations that will become apparent upon reading and understanding the present specification, the present invention discloses a system and method for a life management server to detect the presence of neighboring devices, authenticate the neighboring devices, determine the information content contained within the neighboring devices, and to facilitate a synchronization of the content between the life management server and the neighboring devices. The synchronized data may then be disseminated by the life management server to any one or all of the neighboring devices as required.

In accordance with one embodiment of the invention, a method of providing life management services within a home network comprises detecting the presence of home devices within the home network, comparing information content within the home devices to corresponding information content contained within a home server, updating the corresponding information content within the home server in response to a mismatch between the home device content and the corresponding content contained within the home server, and disseminating a portion of the corresponding information content that is to be shared with other home devices of the home network.

In accordance with another embodiment of the invention, a life management network comprises a plurality of home devices proximately coupled to the life management network and adapted to maintain time dependent information. The life management network further comprises a life management server adapted to detect the plurality of home devices within a circumference. The life management server comprises a first storage area adapted to reflect the time dependent information of each of the plurality of home devices and a second storage area adapted to reflect time dependent information to be shared between the plurality of home devices. The life management server detects differences between the first storage area and the time dependent information of each of the plurality of home devices.

In accordance with another embodiment of the invention, a life management server is proximately coupled to a network and it comprises a means for establishing the proximate connection to the network, a means for detecting the presence of devices within the network, a means for comparing internal data to data stored within each device, and a means for synchronizing the internal data to the data stored within each device.

In accordance with another embodiment of the invention, a computer-readable medium having instructions stored thereon which are executable by a home platform performs steps comprising establishing a proximate connection to a network, detecting the presence of devices within the network, comparing internal data to data stored within each device, and synchronizing the internal data to the data stored within each device.

In accordance with another embodiment of the invention, a home network comprises a plurality of home devices that are coupled to the home network and are adapted to exchange content with the home network. The home network further comprises a content server that is coupled to the home network and is adapted to exchange content with the plurality of home devices. The content server comprises a Local Area Network (LAN) interface coupled to the plurality of home devices and a service discovery module that is adapted to receive subscription requests from the plurality of home devices. The notifications to the plurality of home devices are sent by the content server in response to the subscription requests when content within the content server has changed.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates an exemplary proximity network in accordance with the present invention;

FIG. 2 illustrates an exemplary synchronization network in accordance with the present invention;

FIG. 3A illustrates an exemplary home network in accordance with the present invention;

FIG. 3B illustrates an alternate embodiment of an exemplary home network in accordance with the present invention;

FIG. 4 illustrates an exemplary flow diagram in accordance with a method of the present invention; and

FIG. 5 is a representative computing system capable of carrying out life management functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a method and apparatus that is targeted at the home domain to facilitate life management functions, such as leisure, presence and time management services. Such services may consist of, for example, providing a centralized copy of each home members' personal calendar, which may consist of private information relative to each home member as well as office and other work related information. In addition, a home specific calendar may be maintained within a life management server that contains general information relating to all home members. The general information is not necessarily limited to calendar information, but may also be a placeholder for presence information, service descriptions, and leisure content such as subscriptions to news, rich media downloads, etc.

The present invention also supports synchronization of information between all relevant devices within the home domain. That is to say that the present invention, for example, allows tracking of time events and changes to user specific data that may impact the other members of the home domain. As such, each member's device is tracked through detection of that member's presence within the home domain. Once detected, the member's device may be interrogated by the life management server to determine whether new information exists on the member's device that should be synchronized with the other members of the home domain. If needed, each member's personal calendar and the home specific calendar is updated with the new information existing on the member's device. The new information is not limited to only time specific information that may be related to calendar entries, to do lists, or even daylight savings time transition updates, but may also include virtually any media content that is capable of being shared between the life management server and the other devices within the home domain.

In particular, the media content may include the support of leisure information services, such as news or other information obtained by one home member. In such an instance, for example, the home member may subscribe to daily, weekly, or monthly electronic periodical distributions that contain digital content such as magazines, downloadable games, etc. Once received by one member of the home domain, the life management server may automatically, through the use of proximity networks and service discovery procedures: detect the presence of the digital content on the member's device; upload the digital content from the member's device; and distribute the digital content for display/consumption on the other members' devices, or distribute the digital content to external devices for future consumption or storage.

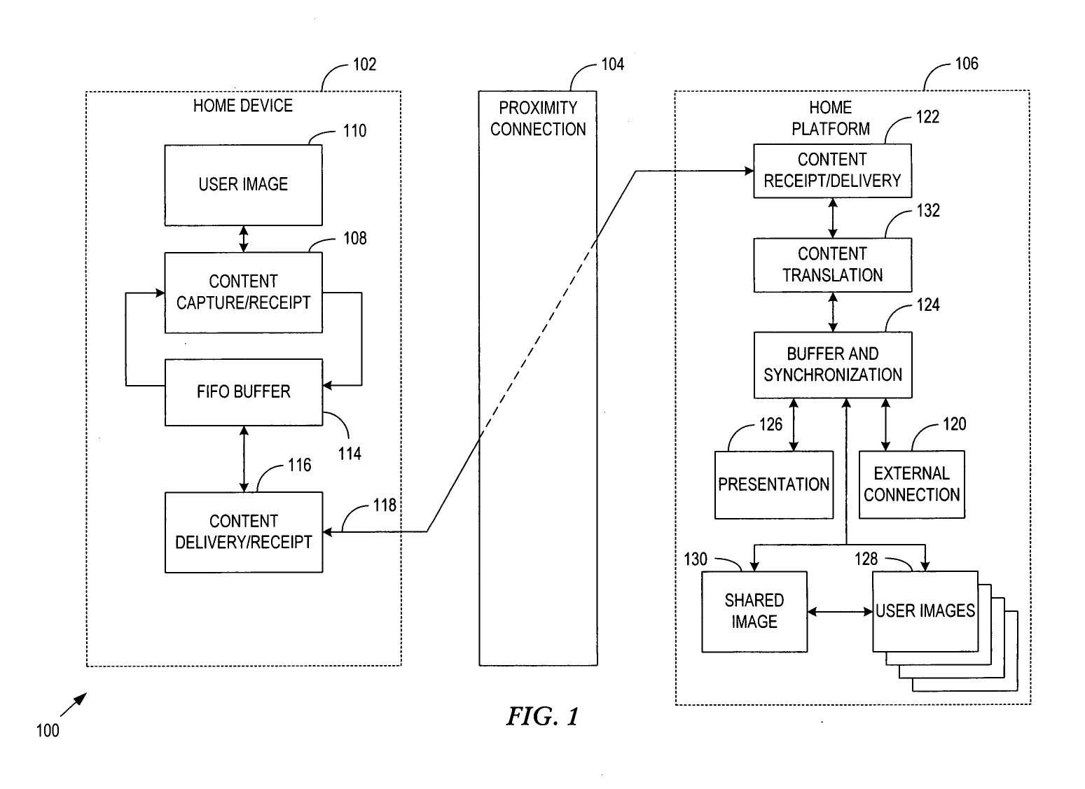

FIG. 1 illustrates a high level block diagram illustrating exemplary proximity network 100 in accordance with the present invention. In general, home device 102 is arranged to exchange data with home platform 106 via path 118. The nature of the data transfer may be of any type and rate that is supported by proximity connection 104, home device 102, and home platform 106. One of ordinary skill in the art will recognize that any data type may be supported by such an arrangement. The data, for example, may be synchronization data that is transferred by home device 102 to home platform 106, e.g. a life management server, in order to obtain a common data store, e.g., user image 128, between the two devices. In one embodiment according to the present invention, synchronization may be performed via a data synchronization standard such as SyncML.

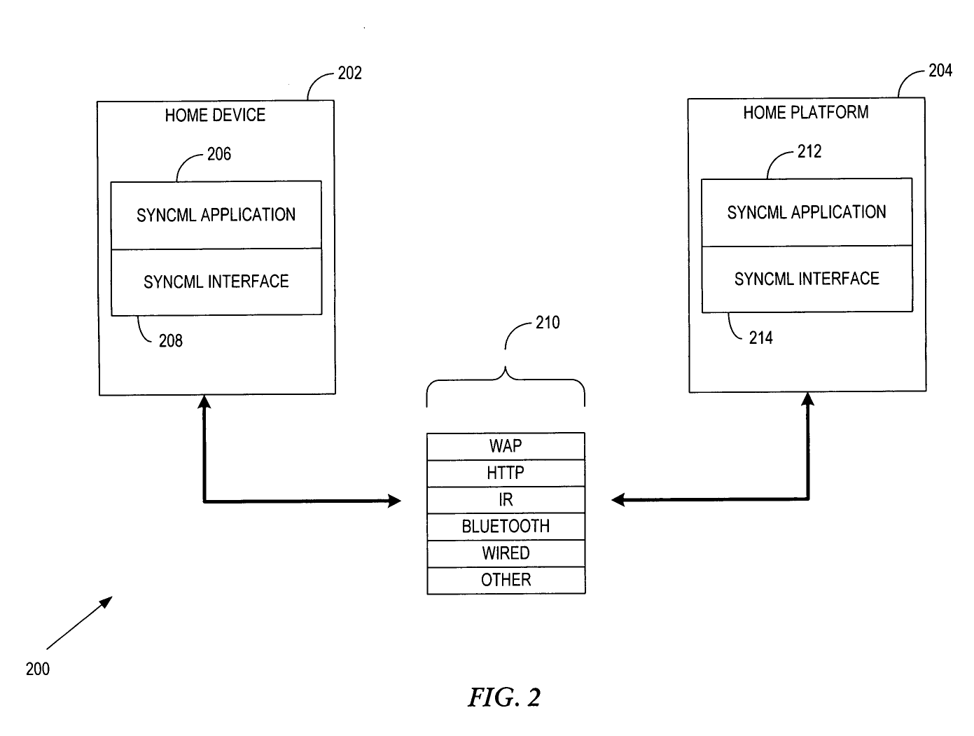

The synchronization data may support such activities as calendar synchronization, time of day synchronization, contact synchronization, to-do list synchronization, subscription media downloads, and games, etc. as required between home device 102 and home platform 106 to provide such a common data store. SyncML may also support data types such as images, files, and database objects. In general, SyncML compatible applications running on home device 102 and home platform 106 may support universal connectivity regardless of platform, manufacturer, or application. An exemplary block diagram of a SyncML enabled network is illustrated in FIG. 2.

Home device 202 and home platform 204 each contain SyncML application/Sync ML interfaces 206, 208 and 212, 214, respectively. In limited bandwidth environments, for example, SyncML network 200 may format the data packets exchanged between home device 202 and home platform 204 into Wireless Application Protocol Binary eXtensible Markup Language (WBXML) to keep the packets of transmitted data as small as possible.

SyncML is capable of synchronizing data over many different protocols 210 that are currently in use by wireless and networked applications today. For example, SyncML works smoothly and efficiently over: the Internet via the HyperText Transport Protocol (HTTP); the Wireless Session Protocol (WSP) via WAP; ad-hoc wireless links implemented with Bluetooth or InfraRed (IR) via the Object Exchange (OBEX) protocol; email standards such as the Simple Mail Transfer Protocol (SMTP), Post Office Protocol version 3 (POP3), or Internet Message Access Protocol (IMAP); or other proprietary wireless communication protocols.

For purposes of exemplifying the present invention, proximity network 100 is discussed in terms of a content transport mechanism between home device 102 and home platform 106, whereby proximity connection 104 is utilized as the communication conduit between the two devices via a SyncML enabled exchange. As discussed in relation to FIG. 2, proximity connection 104 may represent a wired and/or a wireless connection. Wired implementations of proximity connection 104 may include single ended data transmission formats such as those specified by the RS232 or RS432 standards, or may include differential data transmission formats such as those specified by the RS422 or RS485 standards. Other wired implementations for higher bandwidth considerations may use the Universal Serial Bus (USB), or FireWire specifications for example. Other wireless implementations of proximity connection 104 may include Wireless Local Area Network (WLAN) as required by the particular application.

In operation, home device 102 may be a mobile terminal having content capture/receipt capability 108 providing both audio and video data. FIFO buffer 114 buffers the content blocks, while content delivery/receipt 116 prepares for their subsequent transfer to content receipt/delivery 122 of home platform 106 via path 118 through proximity connection 104. Any translation of content received or transmitted to home device 102 may be translated by content translation 132. Buffer and synchronization block 124 is used to provide the proper frame alignment and playback speed as required by presentation 126. Presentation 126 represents any Application Programming Interface (API) that is executing on home platform 106 (or other peripheral device) to support audio/visual presentations locally, whereas external connection 120 supports remote audio/visual processing functions as required.

User images 128 provide data stores that are used to “mirror” each home device's information. In particular, a one-to-one correspondence exists such that each home device 102 of the home network is automatically linked to its respective user image 128 contained within home platform 106. Once synchronized with home platform 106, each home device's local information image is equivalent to its corresponding user image 128. Shared image 130 provides a common data store, whereby data contained within each user image 128 that is meant to be shared among all home devices of the home network is stored within shared image 130. Such shared image information includes, for example, time related information that may impact each home device in the home network, or conversely, data that is gathered by one home device and subsequently shared to the rest of the home devices in the home network.

In one embodiment according to the present invention, proximity connection 104 of FIG. 1 may provide a conduit that is used by a service discovery mechanism, whereby new data contained within home device 102 is first discovered and then uploaded to home platform 106 for subsequent dissemination to the home network or storage for future reference. Various service discovery scenarios are contemplated, such as the Universal Plug and Play (UPnP) approach, whereby data discovery operates according to the Simple Service Discovery Protocol (SSDP). SSDP uses HTTP over User Datagram Protocol (UDP) and is thus designed for usage in IP networks, where peer to peer mechanisms are enabled for auto configuration of devices, service discovery, and control of services.

The UPNP interface provides home platform 106 with the ability to query UPNP devices, e.g. devices that include a Content Directory Service (CDS), in order to get updated information of content stored in those devices, such as a digital program previously recorded by a Personal Video Recorder (PVR) using schedule programming. In such an instance, home platform 106 receives a trigger from the PVR to begin the synchronization process of updating home platform 106 with the newly recorded content in the PVR. Home platform 106 may then include a Session Initiation Protocol (SIP) interface to enable a subscription by home device 102 to home platform 106, such that notifications about the PVR update, for example, may be received by home device 102. In addition to the SIP notification to home device 102 of the content change, home platform 106 also provides a link to the content and the protocol required for accessing the content. The link may include a pointer to a UPNP media server, or a pointer to a SyncML engine to synchronize the content with content contained within home device 102.

The UPnP approach is increasingly useful due to the adoption of digital formats in home entertainment devices such as TVs, home theatre receivers, and DVD players. Each of these home entertainment devices, for example, may use the IEEE 1394 standard for short distance, isochronous media transfer and control. IEEE 1394 also has the capability to transport Internet Protocol (IP), which enables UPnP technology over IP to extend into the home entertainment device network. As such, bi-directional media transfer between home device 102 and the home network may include layer 2 bridging, layer 3 routing, or even content translation at an application layer.

Proximity connection 104 may also be exemplified in terms of the Bluetooth standard for localized discovery and data transfer. Bluetooth technology is an industry standard for short-range wireless voice and data communications, allowing a single air interface to support local communications for distances of up to 10-20 meters. Bluetooth operates in the 2.4 gigahertz (GHz) Industrial, Scientific, and Medical (ISM) band. It uses a fast frequency hopping scheme with 79 frequency channels, each being 1 MHz wide.

Like many other communication technologies, Bluetooth is composed of a hierarchy of components, i.e., a communication stack, which may be broken into two main components. The first component, a Bluetooth Host Controller (BTHC), provides the lower level of the stack, which is generally implemented in hardware to allow the second component, Bluetooth Host (BTH), to send or receive data over a Bluetooth link and to configure the Bluetooth link. Bluetooth also incorporates a Service Discovery Protocol (SDP) as a middleware protocol of the Bluetooth stack. The SDP is used to locate and describe services/data provided by or available through another Bluetooth device. The SDP performs this task by performing two main functions: discovery of devices and services/data within the local area, and the advertisement of services/data from the local device. If, for example, a Bluetooth enabled device can provide newly received subscription content, then that service is made visible, i.e., advertised, through the SDP to the home network for subsequent discovery by the home platform and dissemination to the other members of the home network.

In order for Bluetooth service/data to be advertised, it must first be represented by a service record and kept within an SDP database for access by home platform 106. A service record is created through the SDP database by managing a collection of service handles and associated attributes that make up the service record, where each service record is identified by a Universally Unique Identifier (UUID). Within each service record, a service class and associated profile exist and they are used to help generalize the types of services/data provided by home device 102. There are, for example, predefined service class numbers that may represent a Bluetooth enabled mobile terminal and a more specific entry to define that the Bluetooth enabled mobile terminal also has image capability that may support either still frame or streamed video exchange with home platform 106.

In one embodiment according to the present invention, for example, the service discovery or SyncML procedures discussed above may be used to detect changes in information previously exchanged between home device 102 and home platform 106. Such would be the case, for example, when a user's personal electronic calendar contained within user image 110 was previously synchronized with the image of the user's calendar existing on home platform 106, e.g., user images 128. In such an instance, once the presence of home device 102 is detected by home platform 106, home platform 106 compares user image 110 to user images 128. If differences between the two images exist, then home platform 106 initiates a synchronization event, whereby another data exchange brings the two images back to a one to one correlation with one another.

In another embodiment according to the present invention, home device 102 maintains status attributes that are associated with user image 110. For example, once user image 110 has been synchronized with home platform 106, an attribute, e.g., “status”, that is associated with user image 110 is updated to a value of, e.g., “current”. Subsequent queries of the “status” attribute by the service discovery mechanism of home platform 106 yields a synchronization decision in the negative concerning user image 110, since the status of user image 110 is verified as being “current”. In such a case, updates to user images 128 is not needed, since user image 110 and the corresponding image of user images 128 are in agreement.

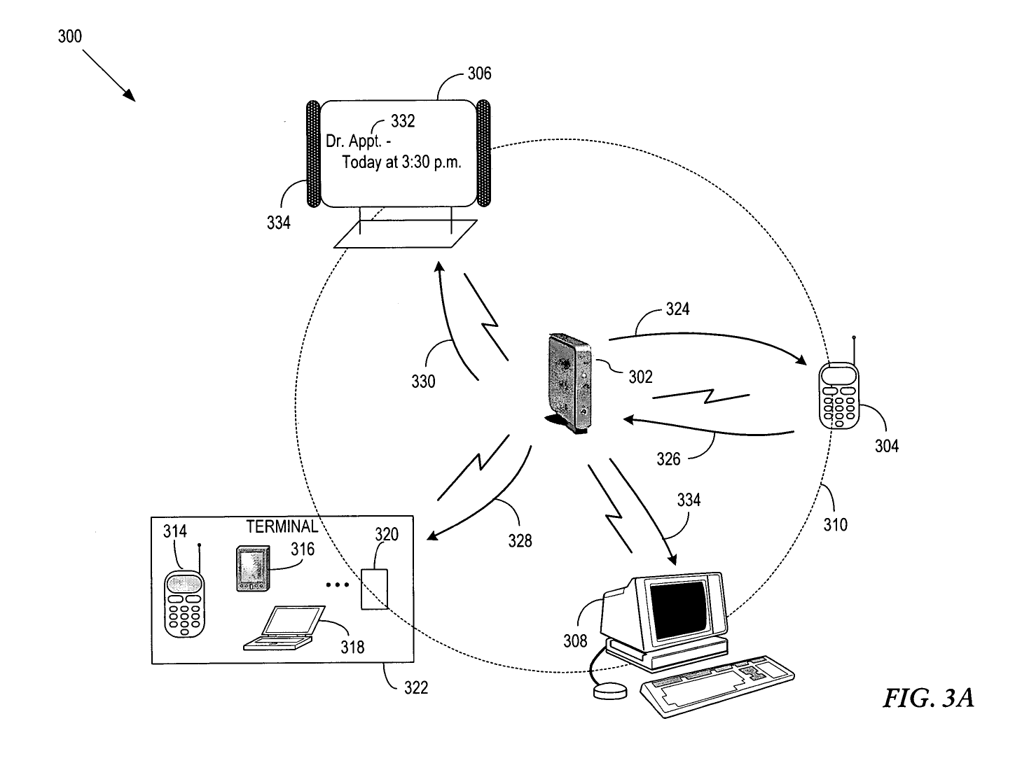

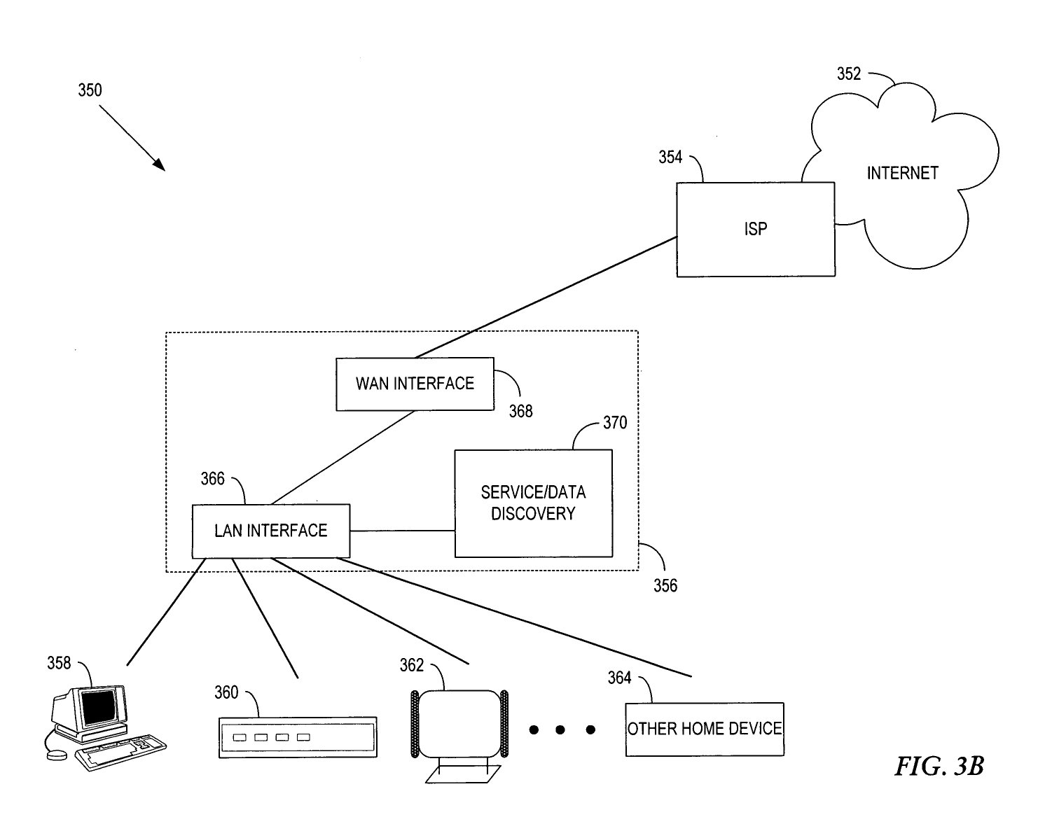

Subsequent changes, however, made by the user of home device 102 to user image 110, would then necessitate the associated status attribute to indicate, for example, a “modified” value. Once the service discovery procedures taken by home platform 106 verify that user image 110 has been changed, then a data synchronization occurs between home platform 106 and home device 102 as discussed above. Turning to FIG. 3A, an exemplary synchronization event is discussed in relation to home network 300 and proximity network 100 in accordance with the present invention.

Life management server 302 is part of home network 300, whereby proximity 310 illustrates a detection circumference within which home devices 304-308, and 322 may be discovered by life management server 302. The discovery performed by life management server 302 may be in accordance with any number of protocols, including those discussed above in relation to UPnP/SSDP and Bluetooth/SDP. Mobile terminal 322 may include any number of home devices, such as mobile terminal 314, PDA 316, laptop computer 318, or other mobile device 320. In addition, the discovery performed by life management server 302 may include an authentication event using local network security credentials to determine whether home devices 304-308 may access home network 300.

All of home devices 304-308, and 322 maintain information, e.g., user image 110 of FIG. 1, that may be synchronized with life management server 302, such as calendars, to-do lists, telephone directories, rich media, etc., after positive authentication of home devices 304-308 has occurred. The information may be date and time tagged and may relate to important events taking place in each user's life, such as events listed in a personal calendar of each home device. Attributes associated with the calendar information may also be maintained in order to determine, for example, the currency status of the information, where currency may be defined in any number of ways.

Currency, for example, may be defined by a time window, such that any user images 128 that are older, i.e., falling outside the defined time window, than the corresponding user image 110 on home devices 304-308, and 322, are determined to be stale. Once discovery has determined that a stale status exists, an automatic synchronization event is initiated by life management server 302 to synchronize the two images. Such a synchronization event is illustrated by communication paths 324 and 326, which are initiated by the service discovery mechanism of life management server 302, once the position of mobile terminal 304 is detected to be within circumference 310.

The service discovery mechanism of life management server 302 may determine the currency of information contained within each of home devices 304-308, and 322 by automatically performing a comparison of each respective user image with its corresponding image in user images 128, or conversely by checking the status of all attributes that are associated with each user image. The latter of the two comparison techniques yields a lower bandwidth solution, since information transfer only takes place when user image 110 is out of synchronization with its corresponding image in user images 128.

If an entry does not exist within life management server 302 that corresponds to a received status, then updated information for that entry is automatically requested since it is a new entry that must be “mirrored” by life management server 302. In other words, updated information is returned, for example, via path 326 by mobile terminal 304 in accordance with the information update request, which synchronizes user image 110 contained within mobile terminal 304 to its associated user image contained within home management server 302, e.g., one of user images 128 of FIG. 1.

In some circumstances, user image data received from one of home devices 304-308, and 322 by life management server 302 may be disseminated amongst the remaining home devices. In such an instance, the user image data received is data that is to be shared among all members of home network 300 and thus stored within shared image 130. Accordingly, home devices 308 and 322 receive the shared information update via path 334 and 328, respectively, from life management server 302 so that their corresponding user images may be updated with the shared information. It should be noted that while home device 308 may be updated immediately with the shared information due to its relatively static position within circumference 310, the information update to home device 322 occurs when life management server 302 has detected the position of home device 322 to be within circumference 310.

In one embodiment according to the present invention, shared information updates may be distributed to audio/video devices within home network 300, for example, to serve as calendar reminders to each user of home network 300. In particular, path 330 may denote a shared information update path to video display device 306, which is a reminder of the appointment, e.g., “Dr. Appt.—Today at 3:30 p.m.”, for the user of mobile terminal 304. The shared information update results in the video display of message 332 onto video display device 306.

In such an instance, life management server 302 compares the context profile of mobile terminal 304, e.g., the relative position of mobile terminal 304 to video display device 306, and determines that a likelihood exists that the user of mobile terminal 304 may see message 332 if displayed onto video display device 306. As such, message 332 is sent to video display device 306 via path 330 by life management server 302 and is automatically displayed by video display device 306. In addition, video display device 306 may also employ Text to Speech (T2S) technology, whereby message 332 may be converted to speech and provided as an audible alert via speakers 334. In this way, even if the user of mobile terminal 304 does not have line of sight access to video display device 306, he may nevertheless be within earshot of video display device 306 so that message 332 may be alerted audibly rather than visually.

In an alternate embodiment according to the present invention, mobile terminal 304 may direct a message via path 326 to life management server 302 for immediate update to home devices 306-308, and 322. In such an instance, messages such as “gone for a walk” or “please stir the stew on the stove” may be disseminated throughout home network 300, such that any home device within circumference 310 of home management server 302 receives the message. The message may be communicated in a number of various ways, depending upon the Input/Output (I/O) characteristics of each home device. For example, video display device 306 may display the message to its associated display area, while Personal Computer (PC) 308 may use a combination of audible and visual queues to communicate the message. Still other home devices, such as mobile terminal 314, may provide tactile queues to alert its corresponding user as to the existence of the message transmitted by life management server 302. Various media types may be communicated in this manner, from simple text media to streaming video transmitted via, for example, IEEE 1394 standards.

In an alternate embodiment according to the present invention, media content contained within a home device, e.g., mobile terminal 304, may be disseminated throughout each of the other home devices within the network. In an exemplary scenario, mobile terminal 304 may subscribe to content provided by a content provider within its Radio Access Network (RAN). The content received may represent any media type from simple text to the richer media classifications, e.g., imaging, audio, and video. The media content, for example, may include news media that contains simple text, H.263 video, and Moving Picture Experts Group version 2 (MPEG-2) layer 3 (MP3) audio content.

Once the discovery is made that news updates exist within mobile terminal 304 that are not “mirrored” by life management server 302, a synchronization event is requested via path 324 as discussed above. Alternatively, mobile terminal 304 may manually “push” the media content onto life management server 302 for subsequent dissemination to other home devices in the home network. Mobile terminal 304 may transfer the media as received, or conversely, may translate the media as required by life management server 302. In the event that mobile terminal 304 does not translate the media, a content translation block, e.g., content translation 132 of FIG. 1, within home platform 106 may provide translation services as required. For example, in order for the news media to be compliant with DHWG, for example, life management server 302 may translate the H.263 video into, e.g., MPEG-2 video format. Similarly, life management server 302 may translate the MP3 audio content into, e.g., Linear Pulse Code Modulation (LPCM) format.

In an alternate embodiment in accordance with the present invention, life management server 302 may operate as an Internet Gateway Device (IGD) according to UPNP specifications as exemplified by home network 350 of FIG. 3B. In particular, life management server 356 operates as an edge network inter-connect device between a residential Local Area Network (LAN), via LAN interface 366, and a Wide Area Network (WAN), via WAN interface 368, to provide residential connectivity to Internet 352 through Internet Service Provider (ISP) 354. Life management server 356, for example, may be implemented as a stand-alone device or conversely as a network of UPNP devices and services.

Discovery and access to the services and data provided by home devices 358-364 is facilitated through service/data discovery (SDD) 370. In particular, SDD 370 may include, for example, SyncML, UPNP, BTH, and SIP protocols as required to implement discovery and synchronization of data and services contained within home devices 358-364. Such home devices may include PC 358, PVR 360, video display terminal 362, or other home device 364.

In one embodiment according to the present invention, SDD 370 may operate as a SIP registrar/proxy server, through which any new services and/or data obtained by any one of home devices 358-364 may be signalled to IGD 356 via the SIP “NOTIFY” method. The data may then be downloaded to IGD 356, whereby synchronization of the newly downloaded data or service with the other home devices may be facilitated through the use of the SIP “SUBSCRIBE” and “NOTIFY” methods. In particular, home devices 358-364 may act as SIP user agents that are able to subscribe to content changes taking place within IGD 356, such that once a content change has occurred within IGD 356, the content and its associated pointers may be communicated to the subscribing home devices using the “NOTIFY” method. Once the content pointers are communicated, synchronization of the content change may take place via any of the synchronization technologies as discussed above.

SDD 370 may also operate as a SIP proxy/registrar to provide services to home devices 358-364. For example, an intercom system may be established between PC 358 and video display terminal 362, whereby Voice over IP (VoIP) may be used, for example, to transfer voice communications from PC 358 to video display terminal 362 via LAN interface 366 as facilitated by SDD 370. Alternately, PC 358 may stream media content to video display device 362 through, for example, an Ethernet connection within LAN 366 as enabled by SDD 370. The media stream may then be forwarded onto, for example, an 802.11 access point, e.g., other home device 364, and subsequently forwarded to video display terminal 362 via its wireless interface (not shown).

It should be noted that IP connectivity provides peer-to-peer communications that are independent of the actual transport being utilized. Consequently, one of ordinary skill in the art will recognize that virtually any service scenario may be realized by home network 350. In addition, IP connectivity facilitates authentication services that may be used to authenticate any home devices discussed above in relation to FIGS. 1-3 prior to synchronization. Further, IPsec or another lightweight security transport protocol may be used to provide traffic flow confidentiality during any authenticated synchronization event.

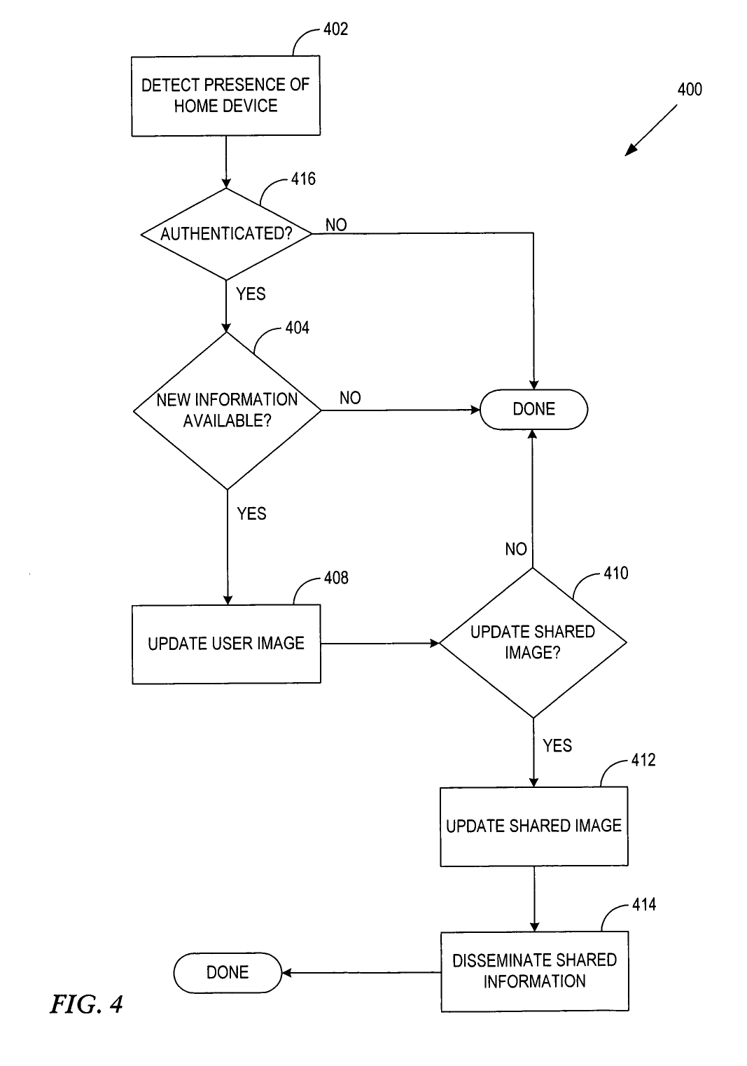

A method in accordance with the present invention is exemplified by the flow diagram of FIG. 4 in combination with home networks 300 and 350 of FIGS. 3A and 3B and proximity network 100 of FIG. 1. In step 402, the presence of home devices 304-308, and 322 is detected by life management server 302, when the home devices fall within circumference 310. Presence detection is performed, for example, through the use of proximity networks and service discovery procedures as discussed above. Authentication of the home devices is performed in step 416 using local network security credentials. If authenticated, then detection of new information is performed in relation to step 404, otherwise, the synchronization session is terminated.

In a first embodiment of step 404, life management server 302 automatically detects differences between user images 128 and user image 110 by comparing the data contained within each image. In an alternate embodiment, life management server 302 simply compares the status attributes associated with user image 110 and downloads only that data that has expired.

If user images 128 of life management server 302 are up to date with the corresponding user image 110, then the “NO” path of step 404 is taken and no synchronization is performed. If, on the other hand, new information is available within any detected home device, then the “YES” path of step 404 is taken and each user image 128 is updated with its corresponding user image 110 as in step 408. Life management server 302 also maintains information that is to be shared with each member of home network 300 within shared image 130. If a synchronization event does occur, then any information that is to be shared is also disseminated among each member of home network 300 in addition to storing the information within shared image 130 as illustrated by steps 410-414.

The invention is a modular invention, whereby processing functions within either a home device or a home platform may be utilized to implement the present invention. The home devices may be any type of wireless device, such as wireless/cellular telephones, personal digital assistants (PDAs), or other wireless handsets, as well as portable computing devices capable of wireless communication. The home devices may also include PC category devices that allow each user to interact with each other via the Internet. Still other home devices include those in the broadcast category that serves set-top boxes and other traditional consumer electronics, such as satellite television (TV) receivers, broadcast tuners, video and imaging capture devices, etc. These home devices utilize computing circuitry and software to control and manage the conventional device activity as well as the functionality provided by the present invention. Hardware, firmware, software or a combination thereof may be used to perform the various home networking functions described herein.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a life management system and method in accordance with the present invention.

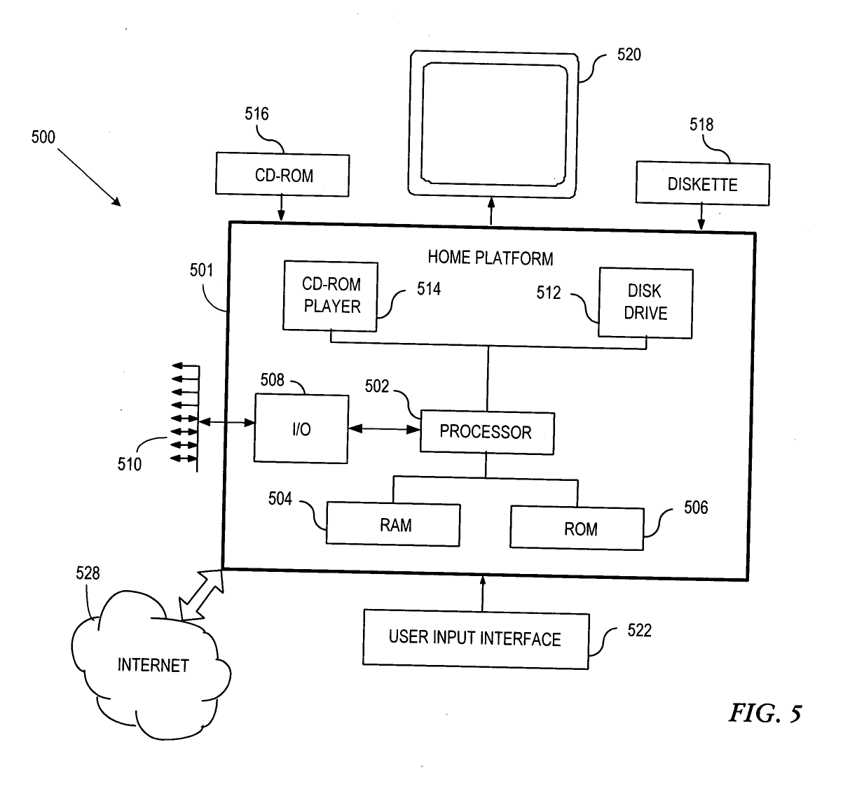

The home platforms and IGDs for providing life management functions in connection with the present invention may be any type of computing device capable of processing and communicating digital information. The home platforms utilize computing systems to control and manage the life management activity. An example of a representative computing system capable of carrying out operations in accordance with the invention is illustrated in FIG. 5. Hardware, firmware, software or a combination thereof may be used to perform the various life management functions and operations described herein. The computing structure 500 of FIG. 5 is an example computing structure that can be used in connection with such a home platform.

The example computing arrangement 500 suitable for performing the life management activity in accordance with the present invention includes home platform 501, which includes a central processor (CPU) 502 coupled to random access memory (RAM) 504 and read-only memory (ROM) 506. The ROM 506 may also be other types of storage media to store programs, such as programmable ROM (PROM), erasable PROM (EPROM), etc. The processor 502 may communicate with other internal and external components through input/output (I/O) circuitry 508 and bussing 510, to provide control signals and the like. For example, data received from proximity I/O connections 508 or Internet connection 528 may be processed in accordance with the present invention. External devices, such as video display units or storage elements, may be coupled to I/O circuitry 508 to facilitate proximity functions according to the present invention. Alternatively, such devices may be local to home platform 501, or otherwise accessible via a home network utilizing proximity detection and service discovery or data synchronization procedures. The processor 502 carries out a variety of functions as is known in the art, as dictated by software and/or firmware instructions.

Home platform 501 may also include one or more data storage devices, including hard and floppy disk drives 512, CD-ROM drives 514, and other hardware capable of reading and/or storing information such as DVD, etc. In one embodiment, software for carrying out the life management operations in accordance with the present invention may be stored and distributed on a CD-ROM 516, diskette 518 or other form of media capable of portably storing information. These storage media may be inserted into, and read by, devices such as the CD-ROM drive 514, the disk drive 512, etc. The software may also be transmitted to home platform 501 via data signals, such as being downloaded electronically via a network, such as the Internet. Home platform 501 may be coupled to a display 520, which may be any type of known display or presentation screen, such as LCD displays, plasma display, cathode ray tubes (CRT), etc. A user input interface 522 is provided, including one or more user interface mechanisms such as a mouse, keyboard, microphone, touch pad, touch screen, voice-recognition system, etc.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method of providing life management services within a home network, comprising:
detecting the presence of home devices within the home network;
comparing information content within the home devices to corresponding information content contained within a home server;
updating the corresponding information content within the home server in response to a mismatch between the home device content and the corresponding content contained within the home server; and
disseminating a portion of the corresponding information content that is to be shared with other home devices of the home network.

2. The method according to claim 1, wherein detecting the presence of the home devices comprises using service discovery procedures.

3. The method according to claim 2, wherein the service discovery procedures include Bluetooth discovery procedures.

4. The method according to claim 2, wherein the service discovery procedures include Universal Plug and Play (UPNP) discovery procedures.

5. The method according to claim 1, wherein comparing the information content comprises:
downloading the information content from the home devices to the home server; and
comparing the information content downloaded from the home devices to the corresponding information content contained within the home server.

6. The method according to claim 5, wherein updating the corresponding information comprises overwriting the corresponding information content contained within the home server with the information content downloaded from an associated home device.

7. The method according to claim 1, wherein comparing the information content comprises:
downloading status attributes associated with the information content within the home devices to the home server; and
detecting a value of the status attributes indicative of a mismatch between the information content contained within the home devices to the corresponding information content contained within the home server.

8. The method according to claim 7, wherein updating the corresponding information content comprises downloading information content from the home devices whose associated status attributes indicate the mismatch.

9. The method according to claim 1, wherein disseminating the portion of the corresponding information content comprises determining the portion of the corresponding information that may be accessed by the other home devices.

10. The method according to claim 9, further comprising transferring the corresponding information that may be accessed by the other devices to the other devices when the presence of the other devices is detected to be within a circumference of the home server.

11. A life management network, comprising:
a plurality of home devices proximately coupled to the life management network and adapted to maintain time dependent information; and
a life management server adapted to detect the plurality of home devices within a circumference, the life management server comprising:
a first storage area adapted to reflect the time dependent information of each of the plurality of home devices; and
a second storage area adapted to reflect time dependent information to be shared between the plurality of home devices, wherein the life management server detects differences between the first storage area and the time dependent information of each of the plurality of home devices.

12. The life management network according to claim 11, wherein the time dependent information comprises information associated with a calendar internal to the plurality of home devices.

13. The life management network according to claim 11, wherein the time dependent information comprises information received in association with a subscription.

14. The life management network according to claim 11, wherein the plurality of home devices include Personal Computing (PC) devices.

15. The life management network according to claim 11, wherein the plurality of home devices include broadcast devices.

16. The life management network according to claim 11, wherein the plurality of home devices include mobile terminals.

17. The life management network according to claim 11, wherein the proximity coupling includes a Bluetooth connection.

18. A life management server proximately coupled to a network, the life management server comprising:
means for establishing the proximate connection to the network;
means for detecting the presence of devices within the network;
means for comparing internal data to data stored within each device; and
means for synchronizing the internal data to the data stored within each device.

19. The life management server according to claim 18, further comprising means for disseminating the internal data to other devices that are detected within the network.

20. A computer-readable medium having instructions stored thereon which are executable by a home platform by performing steps comprising:
establishing a proximate connection to a network;
detecting the presence of devices within the network;
comparing internal data to data stored within each device; and
synchronizing the internal data to the data stored within each device.

21. The computer-readable medium according to claim 20, further comprising instructions to perform a step of disseminating the internal data to other devices that are detected within the network.

22. A home network, comprising:
a plurality of home devices coupled to the home network and adapted to exchange content with the home network;
a content server coupled to the home network and adapted to exchange content with the plurality of home devices, the content server comprising:
a Local Area Network (LAN) interface coupled to the plurality of home devices; and
a service discovery module adapted to receive subscription requests from the plurality of home devices, wherein notifications to the plurality of home devices are sent by the content server in response to the subscription requests when content within the content server has changed.

23. The home network according to claim 22, wherein the content server further comprises a Wide Area Network (WAN) interface coupled to the home network to provide the home devices with connectivity to the Internet.

24. The home network according to claim 22, wherein the service discovery module includes a Universal Plug and Play (UPNP) device used to discover the plurality of home devices.

25. The home network according to claim 24, wherein the service discovery module further includes a Session Initiation Protocol (SIP) device to facilitate the notifications and subscription requests exchanged with the plurality of home devices.

26. The home network according to claim 25, wherein the plurality of home devices include SIP user agents.

27. The home network according to claim 26, wherein the SIP device includes a SIP proxy adapted to enable services between the home devices and the SIP proxy.

28. The home network according to claim 27, wherein the services enabled include Voice over Internet Protocol (VoIP).
